(19) United States
(12) Patent Application Publication
(10) Pub. No.: US 2023/0359167 A1
(43) Pub. Date: Nov. 9, 2023

(54) REMNANT PROCESSING

(71) Applicants: Brenden Morton, Arcata, CA (US); Mark Mendez, Firestone, CO (US)

(72) Inventors: Brenden Morton, Arcata, CA (US); Mark Mendez, Firestone, CO (US)

(21) Appl. No.: 18/142,828

(22) Filed: May 3, 2023

Related U.S. Application Data
(60) Provisional application No. 63/338,171, filed on May 4, 2022.
(60) Provisional application No. 63/455,373, filed on Mar. 29, 2023.

(51) Int. Cl. G05B 19/4093; G06Q 10/087

(52) U.S. Cl. CPC G05B 19/4093; G06Q 10/087; G05B 2219/31431

(57) ABSTRACT

To improve utilization of materials and reduce wastage, there is provided a method for managing remnant materials from a manufacturing process. A digital remnant image of a remnant is obtained and processed to calculate size and shape data for the remnant. A CAD file of the remnant comprising the size and shape data can be created and stored. Remnant CAD files may be searchable so that subsequent design and manufacturing process may make use of the remnants. The remnants may be tagged with an ID, e.g. barcode, that allows the storage location of the remnant to be tracked for retrieval of the remnant when required.

### CROSS REFERENCE TO RELATED APPLICATIONS

This application claims priority to U.S. Provisional Application No. 63/338,171 filed on 4 May 2022 and U.S. Provisional Application No. 63/455,373 filed on 29 Mar. 2023, the entire contents of each of which is incorporated herein by reference.

### FIELD OF THE INVENTION

The present invention relates to design and manufacturing systems and processes and, in particular, to systems and processes that minimize wastage.

### BACKGROUND

In the manufacturing and building industries, materials wastage can be a significant problem. From an entity perspective, wastage reduces profits by not efficiently utilizing purchased resources and by requiring storage or disposal of remnant materials. Time may also be spent in sourcing additional materials unnecessarily. From an environmental perspective, there can be a carbon footprint cost to not utilizing materials as efficiently as possible as well as a landfill or processing cost for disposing of waste materials.

Some entities attempt to minimize wastage by maintaining a store of remnants, offcuts, etc. that can be used in subsequent designs and manufacturing processes. However, these processes tend to be ad hoc and often the entity does not have sufficient knowledge of its store of remnants for those remnants to be incorporated into subsequent design and manufacturing processes.

What is required is a system and process for managing remnants that can facilitate the use of remnants in subsequent design and manufacturing processes.

### SUMMARY OF ONE EMBODIMENT OF THE INVENTION

### Advantages of One or More Embodiments of the Present Invention

The various embodiments of the present invention may, but do not necessarily, achieve one or more of the following advantages:
the ability to account for remnants of a manufacturing process;
the ability to determine the size of remnant pieces from image data;
the ability to maintain a library of remnant pieces including size and shape data;
the ability to generate computer aided design (CAD)-type files describing the size and shape of remnants;
the ability to incorporate remnant inventory into subsequent design and manufacturing processes;
the ability to efficiently load packages into a container with minimal wastage of space;
the ability to calculate packaging instructions for nested packaging into a container.

These and other advantages may be realized by reference to the remaining portions of the specification, claims, and abstract.

### BRIEF DESCRIPTION OF ONE EMBODIMENT OF THE PRESENT INVENTION

In one aspect, there is provided a method for managing remnant materials from a manufacturing process. In the method, a digital remnant image is obtained and processed to calculate size and shape data for at least one remnant in the digital remnant image. A remnant ID is created and a computer aided design file pertaining to the remnant is created that comprises size and shape data for the remnant. The computer aided design file is stored in a searchable database of remnant files.

In one aspect, there is provided a project design method comprising determining material items required for a project, referencing a remnant library of computer aided design files that describe size and shape of remnants available for use in the project design to determine one or more remnants that meet the material items requirements, and generating a fabrication schedule that accounts for remnants that are available for use that meet the materials items requirements.

In one aspect, there is a provided a non-transitory computer readable medium comprising instructions, that when executed by a processor, cause the processor to perform obtaining a digital remnant image, processing the digital remnant image to calculate size and shape data for at least one remnant in the digital remnant image, creating a remnant ID, creating a computer aided design file pertaining to the remnant that comprises size and shape data, and storing the computer aided design file in a searchable database of remnant files.

In one aspect, there is provided a system comprising at least one processor and at least one memory operatively associated with the processor. The processor may be programmed to execute a method. In the method, a digital remnant image is obtained and processed to calculate size and shape data for at least one remnant in the digital remnant image. A remnant ID is created and a computer aided design file pertaining to the remnant is created that comprises size and shape data for the remnant. The computer aided design file is stored in a searchable database of remnant files.

In one aspect, there is provided an electronic device comprising at least one processor and at least one memory operatively associated with the processor. Remnant processing software may be stored by the at least one memory and executable by the at least one processor. The remnant processing software is programmed to process a digital remnant image to calculate size and shape data for at least one remnant in the digital remnant image, create a remnant ID, create a computer aided design file pertaining to the remnant, the computer aided design file comprising size and shape data, and store the computer aided design file in a searchable database of remnant files.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 depicts a flowchart of a method for managing remnants of a manufacturing process;

FIG. 2 depicts an image of a remnant including an image of an object of known size;

FIG. 3 depicts a flowchart of a method for determining size and shape data for the remnant in a CAD-type format;

FIG. 4 depicts a CAD image of a remnant;

FIG. 5 depicts a CAD design of subsequent manufacturing product comprised of potential remnant pieces;

FIG. 6 depicts a computer processing system for executing a remnant processing application in accordance with an embodiment of the invention;

FIG. 7 substantially depicts a remnant feature a defect;

FIG. 8 substantially depicts processing a remnant file to generate pieces from a remnant, taking account of a defect;

FIG. 9 substantially depicts a remnant table that may form a part of a remnant library;

FIG. 10 substantially depicts a package scanning apparatus;

FIG. 11 substantially depicts a flowchart of a method for nested loading of packages into a container; and

FIG. 12 substantially depicts a staging area for loading packages into a container.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Embodiments of the present disclosure will illustrate systems and methods that can be used to manage leftover material from a manufacturing process. In various embodiments, computer vision is used to compare leftover material to an object of known dimensions to determine size and shape data for the leftover material. The dimensions and other characteristics, such as product type, material, etc. are stored in a database or remnant library. A barcode sticker or similar identifying tag, is generated and applied to the leftover material for identifying and tracking the leftover material. The remnant library is then referenced during subsequent manufacturing jobs to find remnants of suitable size and material.

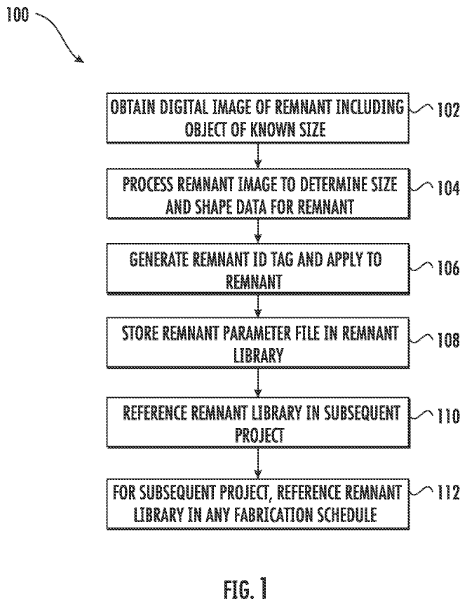

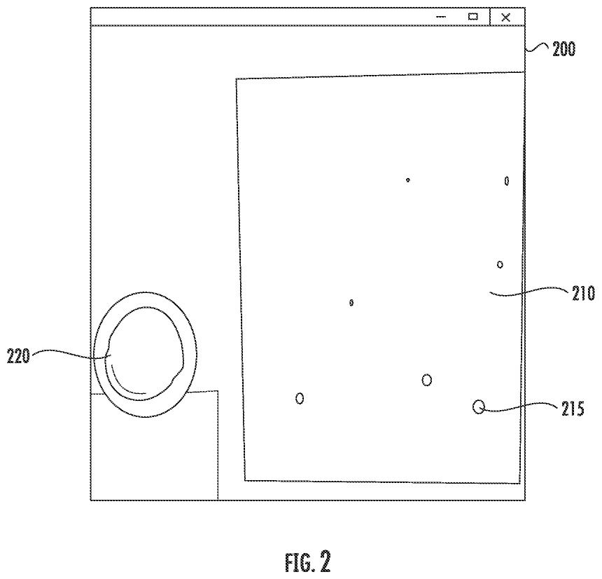

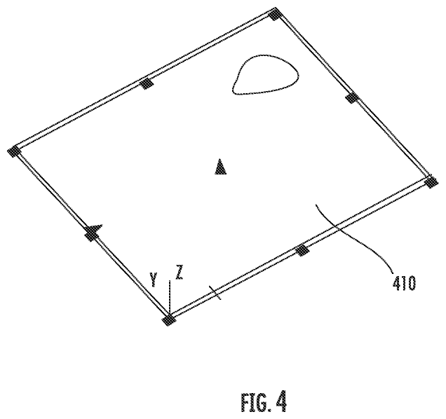

A method in accordance with an embodiment of the invention is depicted in the flowchart 100 of FIG. 1. At step 102, a digital image of a remnant is obtained. An example remnant image 200 is shown in FIG. 2. The remnant image includes an image of a sheet remnant 210 and an image of an object of known size 220. At step 104, the remnant image is processed to determine size and shape data for the remnant. A remnant ID tag may be generated and associated with the remnant, e.g. by affixing a barcode, QR code, or RF ID tag to the remnant (step 106). The physically tagged remnant can now be readily identified and its location catalogued. A parameter file for the remnant may be stored in a database, such as a remnant library (step 108). FIG. 4 shows a dimensioned CAD representation 410 of the remnant 210. The parameter file can then be utilized in subsequent design and manufacturing projects 110. In particular, prior to issuing a fabrication schedule, the remnant library may be referenced (step 112) to ensure that any remnants incorporated into the new project are physically available for use.

The above method expands on remnant logging by using computer vision techniques to ascertain the size and shape of any remnants to produce a 3D shape and dimension file. This allows CAD-type images of the remnants to be produced which can then be used for nesting or otherwise working the remnant into subsequent design and manufacturing processes for new pieces.

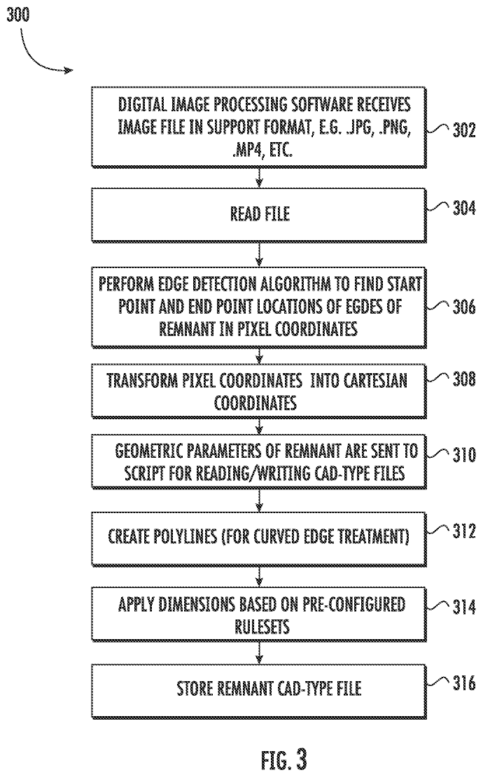

In one embodiment, the computer vision techniques may utilize open source Python libraries to perform image processing including detect object edges, filter out edges/contours that are too small to register, compare the object of known size to the object being measured, and calculate the dimensions of each edge of the object being measured. A particular image processing technique is depicted in the flowchart 300 of FIG. 3. At step 302, the digital processing algorithm receives the digital remnant image file in a supported format, such as .jpg, .png, .mp4, etc. The file is read 304 and then the algorithm undertakes edge detection to determine the start and end point locations of the edges of the remnant, using pixel coordinates (step 306). The edge detection process also detects the boundaries of the object of known size that is included in the digital remnant image. The pixel coordinates are transformed into spatial coordinates, e.g. cartesian coordinates, at step 308 based on known camera location/orientation and using a pixel count comparison between the known object and the remnant. The geometric data (e.g. start point/end point of edges) and any other parameters required for inclusion in a CAD-type file describing the remnant is sent to a C# script (step 310). In one embodiment, the C# script utilizes a netDXF process for reading/writing .DXF files. The C# script utilizing netDXF reads the start point/end point data and creates DXF polylines 312. This process allows for both straight lines and curved edges to be generated. At step 314, dimensions may be applied to the DXF based on pre-configured rulesets. For example, for the rectangular sheet remnant 210 of FIG. 2, the length and breadth might be dimensioned. For a remnant having a circular shape, the dimension may be diameter. For a pipe or conduit remnant, the dimensions may be length, inside diameter, outside diameter. A material of the remnant may also be recorded. At step 316, the DXF filed is stored. While a .DXF file is one type of CAD-type file that may be utilized, other CAD-type files and methods for generating them would be apparent to the person skilled in the art.

Size and shape data may be ascertained using an object of known size, as described above. Alternatively or in addition, LiDAR can be used to determine distances and dimensions of the remnant, and to identify features of the remnant so that they are automatically included in the digital shape file. In one embodiment, stereo cameras can be used to determine distances and dimensions of the remnant. Camera calibration techniques, where the zoom factor and distance from the camera to the object is known, can also be used to determine dimensions of the remnant. In one embodiment, photography techniques to create images that are optimized for the digital processes with which the image is processed may be employed to improve the output of the process. These may include lighting techniques to control or eliminate shadows, and choice of background to create higher contrast. The general idea is to create an image in which the remnant and object of known size are shown with easily identifiable edges, and no intersection of shadows or other obscuring objects or features that may interfere with the computer vision application classifying those edges and reading or applying the correct dimensions to them.

A dimension may be measured manually and applied to the corresponding edge or part of a photo of the remnant, and then the same dimensioning algorithm that compares the object of known size to the remnant and calculates dimensions of the remnant can be used to calculate the dimensions of the remaining edges or parts of the remnant.

Manually drawing the remnant using a custom application, a 3rd party or existing app, may also be provided. This will allow a user to manually measure the dimensions of the remnant and draw the shape of the remnant line by line, and apply the measurements of each edge or part of the remnant to the associated edge or part of the digital shape file as well as assign other parameters such as material data, features, ID tag, location in a way that makes the shape usable as a digitally stored remnant file.

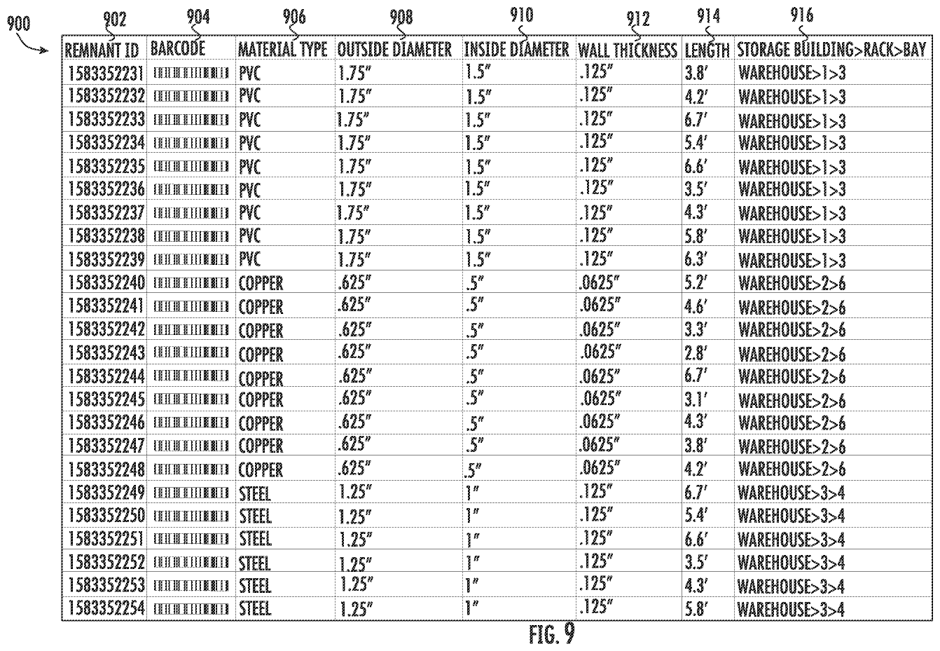

The CAD-type representation of the remnant allows the remnant to be catalogued in a remnant database or library. The remnant may be assigned an identifier. In one embodiment, the identifier may be a barcode, QR code, RF ID tag, or any other suitable identifier. Machine readable tags have particular advantages for location tracking, inventory management, etc. The identifier may be physically attached to the remnant so that the remnant can be permanently identified and its location known up until use. A remnant file may be created that includes the ID, the CAD-type file describing the remnant, the physical storage location of the remnant, and any other relevant information, such as the material, approximate price or value, product category (e.g. sheet, pipe, fabric), etc. The remnant file may be stored in a database, such as a remnant library. The parameters of the remnant file may be searchable. FIG. 9 shows a table 900 of remnant data for a plurality of remnants. In the table 900, each row represents a remnant while the columns provide different remnant parameters. Each remnant has a remnant ID 902, a barcode 904, material type 906, dimension data such as outside diameter 908, inside diameter 910, thickness 912, length 914 and a storage location 916. The storage location 916 may include site location, e.g. warehouse, as well as location within the warehouse, such as bay and rack details.

Because the parameters of the remnant are stored in a CAD-type file, the remnant may be incorporated into subsequent design and manufacturing projects using CAD programs. Thus, a user may design a product and then search the remnant library to determine available remnants that can be used during fabrication of a new piece.

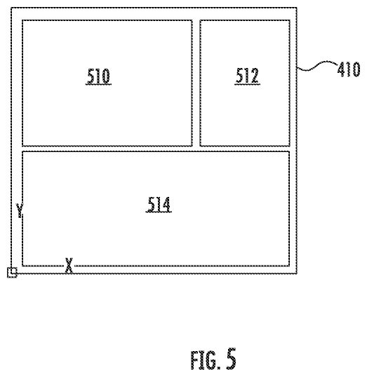

FIG. 5 shows a CAD design process where three required pieces, 510, 512, 514 are cut from the remnant piece 410. The size/shape data is utilized, with material usage efficiency being set through nesting applications or other methods of correlating and fitting the needed part to the available material with minimal waste. The remnant may be identified with a live scan barcode app that indicates when the bar code is physically located with a box drawn around it or some other easily recognizable way of identifying which part is called for by the fabrication schedule.

Taken as a whole this approach can improve material usage efficiency, while saving time and manpower, thus saving money and increasing profits in multiple ways. This can be applied to a variety of materials in addition to sheet goods, such as plumbing materials (e.g. different types of pipe) and materials used in electrical applications (conduit and Unistrut). Most any type of material that is purchased in fixed standard dimensions and then cut or resized as part of a fabrication process to meet the requirements of a job or customer could benefit from this process to increase material usage efficiency and reduce the time and labor spent searching for remnant pieces.

The systems and methods apply to both single-run items as well as multi-run manufacturing processes. That is, a first multi-run process may produce many equal remnants. A second multi-run process may be designed to utilize as many of these remnants as feasible.

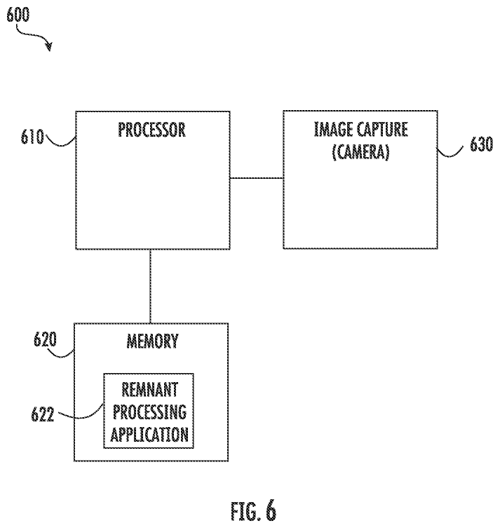

The methods described herein may be embodied as one or more software instruction sets stored as one or more applications in the memory of a computing device(s) and executable by a processor of the computing device. FIG. 6 shows an example of a device 600 including a processor 610 operatively connected to a memory 620 that stores an application 622 that is executable by the processor 610 to provide the remnant processing methods described herein, particularly the method 300 of FIG. 3. In one embodiment, the device may be a mobile telecommunications device such as a mobile phone, tablet, laptop etc. The memory 620 may include read only memory for storing the application software code, digital images, remnant libraries, etc. The memory 620 may also include random access memory for use in execution of the application 622. The device 600 may further include an image capture system 630, such as a digital camera. Image capture software may be stored in the memory 620 and executed by the processor to allow the device to capture an image of the remnant.

In one embodiment, the software application may be configured with a viewer application. The viewer application may enable a user to interact with the image/photo of a remnant object needing to be dimensioned, in order to indicate locations of defects and/or features in the material. Those areas with defects can then be excluded from the digital shape file so that they do not impact the parts that will be made from the remnant, or the digital shape file profile can be modified so that the defective area is not included. Defects may be aesthetic defects, e.g. markings, blemishes, scratches, etc. or defects may be structural defects, e.g. holes, rust, rotten sections, weakened sections, etc. Features that are part of the material can be included in the digital shape file so that parts can be nested on the remnant in a way that makes optimal use of those features. These features may include items such as grain direction, shiplap or tongue-in-groove edge conditions, color or surface conditions. For example, the wood remnant 210 shown in FIG. 2 includes one or more knots 215 in the wood grain. Such features may be considered desirable for aesthetic reasons or may be considered as defects. Thus, remnant processing to design and/or manufacture new pieces may try to include such features or may try to exclude them, depending on preferences. In one embodiment, features (such as edge conditions (lap, tongue or groove, scarf joint, etc), grain direction, color, surface conditions, etc) can be created as digital representations and applied to the remnants, to facilitate the selection of the most suitable remnant for use in subsequent jobs. Material types can also be created and applied to remnants in a similar manner and for the same purpose.

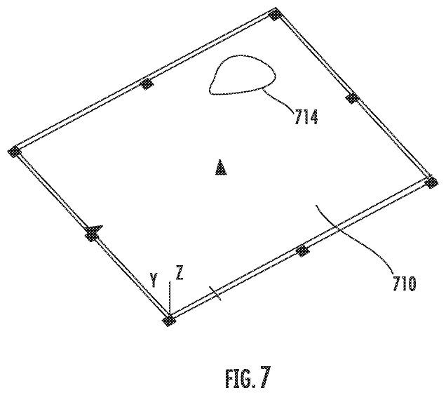

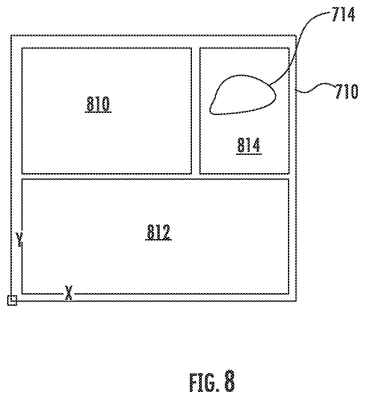

FIG. 7 shows an example of remnant processing that avoids using a blemished area. The remnant 710 is similar to the remnant 410 of FIG. 4 but with a defect (blemish) 714 in one corner. When the remnant 710 is scanned, the remnant processing application may allow the user to indicate the blemish 714, e.g. by tracing out an encompassing perimeter on the remnant image file. The area 714 may be tagged as an aesthetic defect. When it comes to utilizing the remnant 710 as shown in FIG. 8, pieces 810 and 812 may be cut from the remnant. Only the area 814 that contains the blemish may be then be scrapped, thereby ensuring maximum usage of the remnant.

The remnant processing software application, or remnant processing engine, may include an API that provides access to a remnant library for a user or set of users. The API may be customized for each remnant processing engine utilizing the remnant library. The specific type of access utilized may also be dictated by the database in which the remnant library is stored.

The database(s) in which the remnant library is stored for each user or set of users may be supplied as part of a package by the provider of the remnant processing engine, or provided by the user on a local basis. For example, in some cases the provider of the remnant processing engine may also provide the database in which the remnant library is stored through associated cloud services, or the library may be stored on a local machine or network. In either case access for both uploading and retrieving information about the remnants is available through the application and can be utilized by the remnant processing engine and any other necessary users.

In one embodiment, date/time information can be added to each stored remnant, indicating the time and date that the remnant was created. This can be useful in valuing remnants based on time, for materials that have an expiration date or to simply ensure the utilization of remnants in a timely manner. For example, as a remnant ages the remnant processing engine can utilize less stringent constraints around the efficiency of material utilization in order to make the selection of that remnant more likely for any given part or series of parts needing to be cut. The same applies for materials with an expiration date: as a remnant approaches its expiration date, the remnant processing engine has fewer constraints around the efficiency of material utilization in order to ensure that some value is realized from the storing and use of the remnant. An example of this could be that for each week that has passed since a remnant was created, an additional 10% of material waste is allowed in the usage of a part or series of parts, in order to make the selection of that remnant more likely. These changing constraints based on the age of the remnant can be registered and monitored as part of each remnant file and taken into account as part of the remnant utilization process.

In one embodiment, dimension data of scanned items may be used to generate a regularly shaped (consistent length, height, and width) 3D shape file for use in nesting programs. For example, through reconstruction of the dimensions based on a digital measuring of two of the surfaces of an item, a 3D shape file, e.g. rectangle, may be generated. This could be achieved with both LiDAR and/or photogrammetry techniques, as detailed previously. Those 3D shape files can then be used in nesting processes to achieve greater efficiency in arranging objects in three dimensional spaces, e.g. filling a truck or aircraft more quickly and with less wasted space. For example, if a conveyor belt is running with a series of packages on it, it can run past a station where two of the surfaces of the package get digitally measured. From the digital images, a reconstruction of the entire package can be developed as a digital 3D shape file for use in nesting multiple packages into a vessel or other conveyance with a minimum of wasted space and wasted time. If a barcode, QR code, RFID tag or other identification device is present on the package, that identification data can be associated with the digital shape file for use later in the nesting process. This can facilitate the automation of arranging and placing the packages into the available 3D space, using robotics or other automation equipment to manipulate the packages into the correct orientation and move them into the indicated location to maximize the use of space in a highly efficient manner.

Remnants can be materials other than sheet goods, and still be used in applications that include nesting parts to be cut for fabrication to increase material and time efficiency. In instances where the required dimension data for a remnant is primarily length, the data may be stored in a table or other type of text file rather than a digital shape file. This may include pipe or conduit used for mechanical, electrical or plumbing fabrication, hanger material (such as unistrut or all thread), lumber or other composite or laminated material, or any other rough stock material which gets cut into prescribed lengths for fabrication or other purposes. The table or text file containing the length data may also contain other types of data, such as the material type, width or diameter information, remnant tracking information (such as a barcode, QR code or RFID information), storage location information, or anything else that facilitates the storage, location and consumption of the remnant later to be nested upon for greater efficiency. This data can also be input through the app and stored in a format that makes it available for nesting applications and facilitates the location and use of the remnants in a manner similar to what is described above for sheet goods.

Storage locations can be created digitally and have an ID tag associated with the physical and digital location, so that when a remnant is placed it a storage location, the ID tag of the remnant is scanned and then the ID tag of the storage location is scanned (or vice versa) so that the remnant is associated with the storage location and that storage location can be indicated as where the remnant is stored when the remnant is called for by the nesting algorithm for subsequent jobs. Each storage location may have a substantial number of remnants identified by barcodes, QR codes, RFID tags, or other methods used to identify and track these remnants. In one embodiment, an application using the camera of a smartphone or tablet, or other features (for reading RFID tags) allows a user to scan a series of these ID tags so that the correct one can be identified and indicated, facilitating the location of the specific remnant called for by the nesting algorithm for the upcoming job. Once the correct remnant has been identified, located and transported to the workstation where it will be cut, the ID tag can be scanned again, and the name of the associated nested cut file will be pulled up to facilitate the cutting of the remnant.

Analytics and material quantity tracking may be added as part of the app. These may include systems to facilitate tracking of quantities of remnant material (square footage or linear footage) by material type, including associated features. This will simplify any accounting activities that may include remnant material, as well as any other business activities, such as inventory tracking, which may be achieved by making data from the app available to other business management software, such as an ERP system, through direct connection (API's) or other types of data exchanges.

In one embodiment, a dynamic nesting algorithm may include the capability to nest in a more dynamic fashion, taking the size and dimension data as it is generated and outputting a placement for the packages, taking into account the order in which they arrive at the packing location. This allows the algorithm to adapt when not all of the elements to be placed are known in advance of the nesting being started. As time may be a consideration in the packing of the containers, the sequence in which the packages arrive may be a critical part of the nesting process, so the nesting will need to reflect that order in its placement and orientation output. This may result in a less optimal nest in terms of space utilization, but in scenarios where time is of the essence and multiple iterations to arrive at an optimized nest are not possible, value will still be provided and improvement over placing packages without considering the arrangement is almost certain. This dynamic nesting provides the advantage of greater speed while still improving space utilization.

Machine learning may be applied to the above-described dynamic nesting algorithm, in order to improve the process based on accumulated data around the sizes, shapes and quantities (percentages) of the parcels that have been run through the system previously. Once a database of the package information is available, the machine learning model may be run repeatedly based on that data. This will accelerate the improvement of the algorithm by allowing iterations of the nesting process to take place virtually, but still based on actual package data, rather than in real time as the packages are going through the process.

A custom application may be developed to aid in the capture of the size and shape data, as the packages move by on a conveyor belt. This may involve the use of multiple sensors and the reconstruction of the packages into 3D shape files based on Iterative Closest Point or similar algorithms. This may allow for reconstruction of the entire package with the capture of only two adjacent sides in the case of regularly shaped parcels, or the development of a 3D shape file from a more complete scanning of the parcel in the case of irregularly shaped packages.

For scenarios in which the packages will be placed manually into the container following instructions output by the nesting algorithm, the nesting may be output in multiple different formats, including an animation that can be displayed on a screen, or an augmented/extended reality application that would be available through AR/XR goggles or glasses.

Vacuum lifts, robotic arms, or other equipment may also be used to lift, orient and place the packages, directed either through the above-described methods for manual placement, or with varying levels of automation.

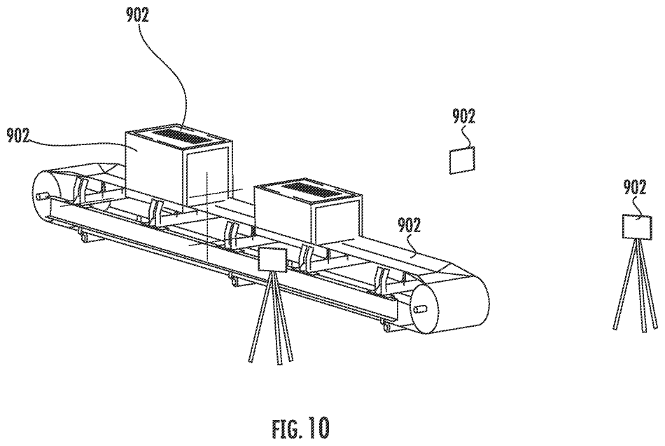

FIG. 10 shows an embodiment of an apparatus for providing algorithmically based nested packaging into a container. The apparatus 1000 includes a conveyor 1010. Disposed around the conveyor are a serios of sensors 1020. The sensors 1020 may including imaging sensors such as LiDAR sensors, cameras, barcode scanners etc. Additional sensors such as weight or touch/contact sensors may also be deployed. Collectively, the sensors 1020 are able to monitor the motion of a package 1030 along the conveyor 1010. The sensors 1020 scan the package 1030 and from the sensor data, a processor calculates the dimensions of the package and produces an accurately dimensioned 3D shape file, e.g. a DWG or DXF file. If a barcode, QR code or similar identifier is detected, the code and digital identity of the package can be associated with the shape file.

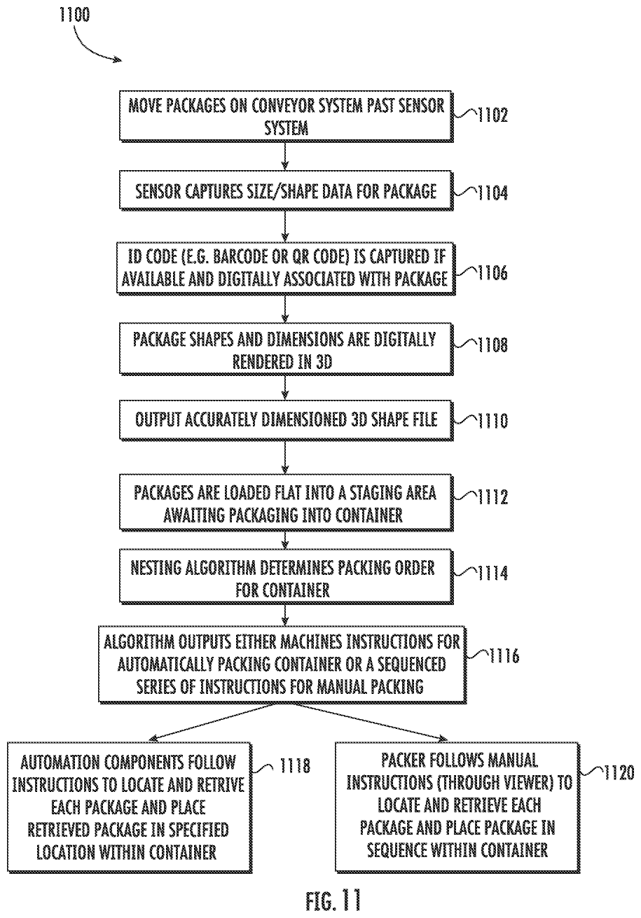

FIG. 11 depicts a flowchart 1100 of a method for nesting packages into a container. At step 1102, a package is placed on the conveyor system of FIG. 10 and moved through the field of the sensor array. The sensors detect the dimensions of the package (step 1104). For a regular shaped package, it may be sufficient to capture two adjacent surfaces of each package. For irregular shaped packages, the sensors may provide a complete scan and utilize edge detection methods for determining size and shape data, as described previously. If available, a barcode or QR code may also be detected and digitally associated with the package (step 1106). At step 1108, the package is digitally rendered and an accurately dimensioned 3D shape file is produced (step 1110). The package may then be conveyed to a staging area to await loading into a container (step 1112). The location of each package in the staging area may be recorded for ease of later retrieval. At step 1114, a nesting algorithm processes a container volume and the size and shape data for the packages awaiting loading into the particular container. The nesting algorithm calculates a packing sequence 1116 and outputs a set of automatic or manual packing instructions. If automatic packing is to be performed, the packing instructions are provided to the automation components, such as lifts, robotic arms, etc. The automation components locate and retrieve the packages based on the packing sequence and the location data of the package file (step 1118). The automation components are then able to load the retrieved package into the appropriate location within the container. Barcode scanning of a loaded package may be used to trigger the next package retrieval in the packing sequence.

Otherwise, if manual packing is to be performed, at step 1120, human followable instructions may be provided, e.g. by printout, or by display on viewable screen. Alternatively or in addition, audible instructions may be provided. The human packer may follow the instructions to locate and retrieve each sequenced package from the staging area and load the package into the appropriate section of the container. The packing instructions may provide detailed loading instructions, including how a package is to be oriented within the container. As for the automated method, barcode scanning of a loaded package may trigger the display of instructions for the next package.

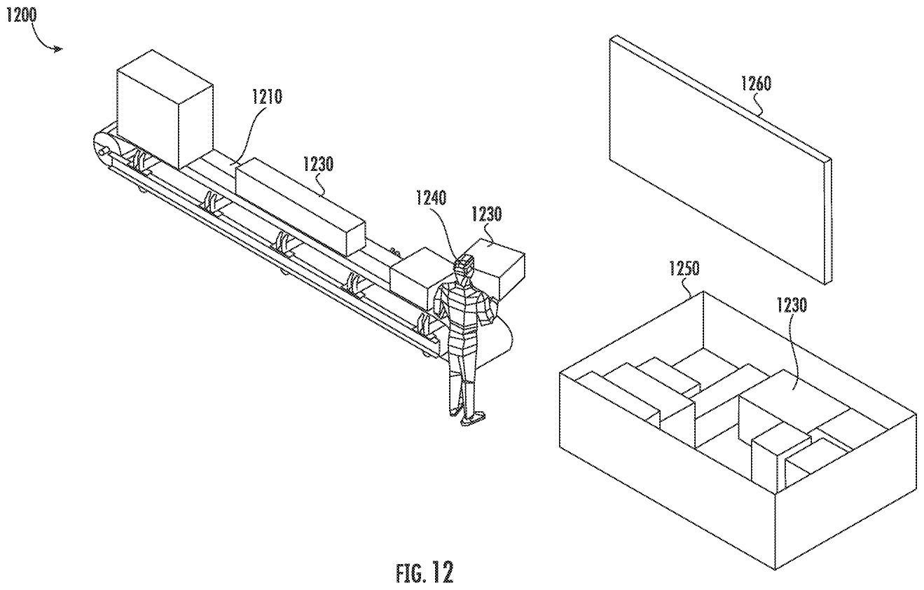

A combination of automation and manual packing methods may be employed. For example, as shown in the depicted staging area 1200 of FIG. 12, an automated system may retrieve packages from their stored location within the staging area and convey the packages 1230 along a conveyor 1210 in their packaging sequence to a human packer 1240 who is situated at the end of the conveyor 1210. The packer 1240 may remove the package from the conveyor 1210 and place the packages in a container 1250. A display screen 1260 may display packing instructions to the packer, including how the package is to be located and oriented within the container 1250.

By utilizing nesting algorithms as described herein, packing of containers can be performed efficiently with minimal wastage of space.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for managing remnant materials from a manufacturing process, the method comprising:
(A) obtaining a digital remnant image;
(B) processing the digital remnant image to calculate size and shape data for at least one remnant in the digital remnant image;
(C) creating a remnant ID;
(D) creating a computer aided design file pertaining to the remnant, the computer aided design file comprising size and shape data;
(E) storing the computer aided design file in a searchable database of remnant files.

2. The method of claim 1 wherein the digital remnant image includes an image of an item of known size, the method comprising using size data ascertained from the item to determine size data for the remnant.

3. The method of claim 1 comprising applying a remnant ID tag to the remnant.

4. The method of claim 1 comprising utilizing the computer aided design file in a design that utilizes the remnant.

5. The method of claim 1 comprising indicating one or more features or indicating one or more defects on the digital remnant image and incorporating size and shape data of the one or more features or one or more defects into the computer aided design file.

6. The method of claim 5 comprising utilizing the computer aided design file in a design that utilizes the remnant wherein the one or more features or one or more defects are accounted for.

7. The method of claim 6 wherein accounting for one or more defects comprises avoiding incorporating the one or more defects of the remnant into a new piece.

8. The method of claim 1 comprising:
(A) determining material items required for a project;
(B) referencing the searchable database of remnant files that describe size and shape of remnants available for use in the project design to determine one or more remnants that meet the material items requirements;
(C) generating a fabrication schedule that accounts for remnants that are available for use that meet the materials items requirements.

9. The method of claim 8 wherein the remnant library stores a location of the remnants, the method comprising locating the required remnants prior to generating the fabrication schedule.

10. A project design method comprising:
(A) determining material items required for a project;
(B) referencing a remnant library of computer aided design files that describe size and shape of remnants available for use in the project design to determine one or more remnants that meet the material items requirements;
(C) generating a fabrication schedule that accounts for remnants that are available for use that meet the materials items requirements.

11. The method of claim 10 wherein the remnant library stores a location of the remnants, the method comprising locating the required remnants prior to generating the fabrication schedule.

12. A non-transitory computer readable medium comprising instructions, that when executed by a processor, cause the processor to perform:
(A) obtaining a digital remnant image;
(B) processing the digital remnant image to calculate size and shape data for at least one remnant in the digital remnant image;
(C) creating a remnant ID;
(D) creating a computer aided design file pertaining to the remnant, the computer aided design file comprising size and shape data;
(E) storing the computer aided design file in a searchable database of remnant files.

13. The non-transitory computer readable medium of claim 12 wherein the digital remnant image includes an image of an item of known size, wherein the instructions, when executed by a processor, cause the processor to perform using size data ascertained from the item to determine size data for the remnant.

14. The non-transitory computer readable medium of claim 12 wherein the instructions, when executed by a processor, cause the processor to perform utilizing the computer aided design file in a design that utilizes the remnant.

15. The non-transitory computer readable medium of claim 12 wherein the instructions, when executed by a processor, cause the processor to perform indicating one or more features or indicating one or more defects on the digital remnant image and incorporating size and shape data of the one or more features or one or more defects into the computer aided design file.

16. The non-transitory computer readable medium of claim 15 wherein the instructions, when executed by a processor, cause the processor to perform utilizing the computer aided design file in a design that utilizes the remnant wherein the one or more features or one or more defects are accounted for.

17. The non-transitory computer readable medium of claim 16 wherein accounting for one or more defects comprises avoiding incorporating the one or more defects of the remnant into a new piece.

18. The non-transitory computer readable medium of claim 12 wherein the instructions, when executed by a processor, cause the processor to perform:
(A) determining material items required for a project;
(B) referencing the searchable database of remnant files that describe size and shape of remnants available for use in the project design to determine one or more remnants that meet the material items requirements;
(C) generating a fabrication schedule that accounts for remnants that are available for use that meet the materials items requirements.

19. A system comprising at least one processor and at least one memory operatively associated with the processor, wherein the processor is programmed to:
(A) obtain a digital remnant image;
(B) process the digital remnant image to calculate size and shape data for at least one remnant in the digital remnant image;
(C) create a remnant ID;
(D) create a computer aided design file pertaining to the remnant, the computer aided design file comprising size and shape data;
(E) store the computer aided design file in a searchable database of remnant files.

20. The system of claim 19 wherein the digital remnant image includes an image of an item of known size, wherein the processor is programmed to use size data ascertained from the item to determine size data for the remnant.

21. The system of claim 19 wherein the processor is programmed to utilize the computer aided design file in a design that utilizes the remnant.

22. The system of claim 19 wherein the processor is programmed to receive an indication of one or more features or one or more defects on the digital remnant image and incorporating size and shape data of the one or more features or one or more defects into the computer aided design file.

23. The system of claim 22 wherein the processor is programmed to utilize the computer aided design file in a design that utilizes the remnant wherein the one or more features or one or more defects are accounted for.

24. The system of claim 23 wherein the processor is programmed to account for one or more defects by avoiding incorporating the one or more defects of the remnant into a new piece.

25. The system of claim 19 wherein the processor is programmed to:
(A) determine material items required for a project;
(B) reference the searchable database of remnant files that describe size and shape of remnants available for use in the project design to determine one or more remnants that meet the material items requirements;
(C) generate a fabrication schedule that accounts for remnants that are available for use that meet the materials items requirements.

26. An electronic device comprising:
(A) at least one processor;
(B) at least one memory operatively associated with the processor;
(C) remnant processing software stored by the at least one memory and executable by the at least one processor, wherein the remnant processing software is programmed to:
(a) process a digital remnant image to calculate size and shape data for at least one remnant in the digital remnant image;
(b) create a remnant ID;
(c) create a computer aided design file pertaining to the remnant, the computer aided design file comprising size and shape data;
(d) store the computer aided design file in a searchable database of remnant files.

27. The electronic device of claim 26 comprising an image capture device and image capture software for capturing the digital remnant image by the image capture device.

28. The electronic device of claim 26 comprising a viewer application that enables the user to interact with the digital remnant image.

29. The electronic device of claim 28 wherein the viewer application enables the user to indicate at least one of one or more features of the remnant or one or more defects of the remnant on the digital remnant image.
